(19) United States
(12) Patent Application Publication
(10) Pub. No.: US 2020/0309338 A1
(43) Pub. Date: Oct. 1, 2020

(54) MOTORCYCLE VISIBILITY LED LIGHT SYSTEM

(71) Applicant: General Products Inc., Winchester, CA (US)

(72) Inventor: Satinder Singh, Winchester, CA (US)

(73) Assignee: General Products Inc., Winchester, CA (US)

(21) Appl. No.: 16/828,512

(22) Filed: Mar. 24, 2020

Related U.S. Application Data
(60) Provisional application No. 62/824,388, filed on Mar. 27, 2019.

(51) Int. Cl. F21S 41/141; F21S 41/657

(52) U.S. Cl. CPC F21S 41/141; F21Y 2115/10; F21S 41/657

(57) ABSTRACT

The present invention is related to a motorcycle LED light system for lighting the ground underneath and around a motorcycle to make the motorcycle more visible, comprising one or more high intensity LED lights situated on or near the rear of the motorcycle and in a direction so that the LED light is projected toward the ground behind and in front of the rear wheel of the motorcycle.

### FIELD OF THE INVENTION

The present invention is related to a safety lighting device for a motorcycle that makes the motorcycle significantly more visible at night while avoiding a significant increase in size of the motorcycle.

### BACKGROUND OF THE INVENTION

There is a continued effort to make motorcycle riding a safer activity, especially in poor light when motorcycles are harder to see on the road. Making the motorcycle more visible at night to other motorists is therefore highly desirable. Similarly, there is a continued effort to make bicycles, also known as pedal cyclists riding a safer activity, especially in poor light when bicycles are harder to see on the road.

It is known to add an additional light source in addition to a brake light to catch the eye of motorists driving behind or around a motorcycle. However, these systems do not make the motorcycle sufficiently visible at night.

U.S. Pat. No. 5,055,983 is purportedly directed to a rear-light assembly for a motor vehicle is positioned at a transition from a rear surface to a side surface of the motor vehicle. A light diffuser thereof has an exterior surface which extends relatively smoothly into the rear and side surfaces of the rest of the body of the motor vehicle. Light-diffuser portions for a brake-light reflector, a taillight reflector, and a fog taillight reflector are provided with linearly arranged exterior-light reflecting rear-beam prisms. In a flat area of the light diffuser, which extends over the fog taillight and taillight, the rear-beam prisms are optically effective while at an adjacent area they are made to be optically ineffective. A light-diffuser portion for a backing light reflector is provided with an opaque lattice, or grill, which includes linearly shaped strips. This light-diffuser portion is also in an area of the light diffuser which extends substantially planar, or flat. Optically-ineffective, rear-beam prisms arranged in strips are in light-diffuser portions which are backed by a reflector to the side of the light-diffuser portion for the backing light.

U.S. Pat. No. 8,550,673 is purportedly directed to a secondary lighting system for providing light to a motorcycle when the motorcycle that is activated when the motorcycle leans into a turn so as to help illuminate the path ahead of the vehicle. The system has a front and a back surface and an inner cavity, a light component in the front surface, a tilt sensor in the inner cavity adapted to detect a tilt angle of a motorcycle, a microprocessor in the inner cavity operatively connected to the tilt sensor and to the light component, wherein when the tilt sensor detects a tilt angle that is greater than a pre-programmed threshold the tilt sensor sends an input signal to the microprocessor whereupon the microprocessor sends an output command to the light component to activate the light component, the light component emits light at a lighting angle

U.S. Pat. No. 6,595,666 is purportedly directed to an orientation sensitive light for mounting on motorcycles and the like, having a light emitter, an orientation sensitive switch, and a power source, all connected in an electric circuit. The light is mounted on the underside of the motorcycle or on a side of the motorcycle, with the light emitter pointing downwards during normal operational orientation of the motorcycle. An orientation sensitive switch has a cavity with a quantity of an electrically conductive liquid such as mercury. The switch activates the light emitter when the motorcycle changes its orientation, as when a front or a rear wheel is raised above the ground.

The present invention seeks improvements over deficiencies in lighting systems for making motorcycles substantially more visible at night without affecting the aerodynamics or significantly increasing the size of the vehicle. The present invention also seeks improvements over deficiencies in lighting systems for making bicycles substantially more visible at night without affecting the aerodynamics or significantly increasing the size of the vehicle.

### OBJECTS AND SUMMARY OF THE INVENTION

It is an object of this invention to develop a lighting system for a motorcycle to make the motorcycle significantly more visible at night while avoiding a significant increase in size of the motorcycle or affecting the aerodynamics of the motorcycle.

It is a further object of the invention to develop a lighting system for a motorcycle that lights the ground in front and back of the rear wheel so that the motorcycle is more visible to traffic behind and in front of the motorcycle without distracting or impairing the rider's view.

It is a further object of this invention to increase the profile of a motorcycle without significantly increasing the physical size of the motorcycle by lighting the motorcycle and/or the ground around the motorcycle.

It is a further object of the invention to develop a lighting system for a motorcycle that lights the ground when viewed from both in front of the motorcycle and from behind the motorcycle.

It is a further object of the invention to develop a lighting system for a motorcycle that lights the ground around the rear wheel of the motorcycle and in the process, also lights the motorcycle itself, without interfering with the field of vision of motorists in surrounding vehicles.

It is also an object of the invention to provide a bigger footprint for a motorcycle without increasing the size of the motorcycle by lighting the motorcycle and the ground around it.

It is a further object of the present invention to provide a method of lighting a motorcycle to increase the profile of the motorcycle without significantly increasing the size of the motorcycle.

It is also an object of this invention to develop a lighting system for a bicycle to make the bicycle significantly more visible at night while avoiding a significant increase in size of the bicycle or affecting the aerodynamics of the bicycle.

It is a further object of the invention to develop a lighting system for a bicycle that lights the ground in front and back of the rear wheel so that the bicycle is more visible to traffic behind and in front of the bicycle without distracting or impairing the rider's view.

It is a further object of this invention to increase the profile of a bicycle without significantly increasing the physical size of the bicycle by lighting the bicycle and/or the ground around the bicycle.

It is a further object of the invention to develop a lighting system for a bicycle that lights the ground when viewed from both in front of the bicycle and from behind the bicycle.

It is a further object of the invention to develop a lighting system for a bicycle that lights the ground around the rear wheel of the bicycle and in the process, also lights the bicycle itself, without interfering with the field of vision of motorists in surrounding vehicles.

It is also an object of the invention to provide a bigger footprint for a bicycle without increasing the size of the bicycle by lighting the bicycle and the ground around it.

It is a further object of the present invention to provide a method of lighting a bicycle to increase the profile of the bicycle without significantly increasing the size of the bicycle.

In connection with the above objects and others, the invention is directed in part to a motorcycle LED light system for lighting the ground underneath and around a motorcycle, to make the motorcycle more visible, comprising one or more high intensity LED lights situated on or near the rear of the motorcycle and in a direction so that the LED light is projected toward the ground behind, in front and around the rear wheel of the motorcycle.

The invention is further directed to an LED light system wherein the motorcycle itself is also illuminated.

The present invention is also directed to an LED light system, wherein the one or more LED lights is integrated with a brake light and, when the brake light is activated, the one or more LED lights grows brighter or changes color to indicate that the brake has been activated.

The invention is further directed to an LED light system, wherein a first LED light of the light system is integrated with a left indicator light and a second LED light of the light system is integrated with the right indicator light and wherein when one of the indicator lights is activated, the integrated LED light grows brighter or changes color to indicate that the indicator has been activated. Alternatively, the invention may be directed to an LED light system, wherein a first LED light of the light system is integrated with a left indicator light and a second LED light of the light system is integrated with the right indicator light and wherein when one of the indicator lights is activated, the integrated LED light flashes on and off or flashes from on to a brighter setting or to a color setting to indicate that the indicator has been activated.

The invention in certain embodiments includes LED light(s) having a lumen range of from about 2400 lm to about 10,000 lm.

The present invention is also directed to an LED light system, wherein at least one LED light is integrated with the brake light and is brighter than other LED lights in the system.

The present invention is also directed to an LED light system providing lighting downward at an angel of about 0 to about 180 degrees, measured from the base of the fender but not intended to shine in the eyes of the driver behind the motorcycle or in front of the motorcycle as conventional braking systems presently do. Alternatively, the present invention is directed to an LED light system providing lighting downward at an angel of about 45 to about 135 degrees, measured from the base of the fender.

The invention further is directed to the LED light system, wherein the LED light system is mounted from the base of the fender or right behind it so as not interfere with the rear view braking system and providing lighting downward at an angel of at least about 45 degrees to about 135 degrees but no more than about 0 degrees to about 180 degrees.

The invention is further directed to the LED light system, wherein the one or more LED lights is curved around both sides of the motorcycle from the back to each side to increase a surface area of light at the sides of the motorcycle to give the motorcycle a bigger light profile such that the motorcycle appears larger and is more visible from different viewing perspectives.

The invention is further directed to the LED light system, wherein at least one LED light is automatically activated when the motorcycle is in operation.

The invention is further directed to the LED light system wherein at least one LED light is only activated when there is low surrounding light (e.g. at night or when there are very dark clouds). Alternatively, the invention is directed to the LED light system, wherein the LED lights are adjustable to allow the angle of the light beam to be changed.

The invention is further directed to the LEI) light system wherein the LED light system is contained in a housing with a brake light and indicator lights as a universal kit to fit a number of different brands and models of motorcycle.

The invention is further directed to the LED light system of claim 1 wherein the LED light system includes LED lights located at or near the front of the motorcycle which light the ground in front and behind the front wheel of the motorcycle.

The invention is directed to a housing for containing lighting for a motorcycle comprising a brake light; left and right indicator lights; and an LED light system comprised of at least one LED light positioned to light the ground around the rear wheel of the motorcycle.

The invention is also directed to the housing having LED light system of claim 15, wherein the motorcycle itself is also illuminated.

The invention is further directed to the housing is a universal kit designed to fit a number of different brands and models of motorcycle.

The invention is further directed to a method of lighting the ground in front and behind a motorcycle so that the motorcycle is significantly more visible at night comprising attaching to the motorcycle an LED light system comprising one or more LED lights which are directed toward the ground at an angel of at least about 45 degrees to about 135 degrees but no more than about 0 degrees to about 180 degrees measured from the base of the back fender of the motorcycle.

The invention is also directed in part to a bicycle LED light system for lighting the ground underneath and around a bicycle, to make the bicycle more visible, comprising one or more high intensity LED lights situated on or near the rear of the bicycle and in a direction so that the LED light is projected toward the ground behind, in front and around the rear wheel of the bicycle.

The invention is further directed to an LED light system wherein the bicycle itself is also illuminated.

### BRIEF DESCRIPTION OF THE DRAWINGS

FIG. 1 is a depiction of a motorcycle having the LED light system mounted from the base of the fender where the brake light is mounted or right behind it and providing lighting downward at an angel of about 0 to about 180 degrees.

FIG. 2 is a view of a motorcycle from behind showing the horizon level marking the 0 and 180 degree angle below from which the LED light system shines down to the ground, with the horizon level being at the height of the seat and/or fender.

FIG. 3A shows a view of a universal light system which includes a combined left indicator lights/LED and a combined right indicator light/LED which indicate direction and project light toward the ground.

FIG. 3B shows a rear view of the universal light system which includes a combined left indicator light/LED and a combined right indicator light/LED which indicate direction and project light toward the ground.

FIG. 3C shows a right side view of a universal light system which includes a combined left indicator light/LED and a combined right indicator light/LED which indicate direction and project light toward the ground at a 90 degree angle.

FIG. 4A shows a view of a universal light system which includes a brake light, indicator lights and a left and right LED light which projects light toward the ground.

FIG. 4B shows a rear view of the universal light system which includes a brake light, indicator lights and a left and right LED light which projects light toward the ground.

FIG. 4C shows a right side view of a universal light system which includes a brake light, indicator lights and a left and right LED light which projects light toward the ground at a 90 degree angle.

FIGS. 5A and 5B show an LED light system of the present invention mounted on a motorcycle fender and giving a 90 degree projection of light toward the ground, with FIG. 5A providing a view from behind the motorcycle and with FIG. 5B providing a side view of the motorcycle.

FIGS. 6A and 6B show an LED light system of the present invention mounted on a sportbike motorcycle fender and giving a 90 degree projection of light toward the ground, with FIG. 6A providing a view from behind the sportbike motorcycle and with FIG. 6B showing a side view of the sportbike motorcycle.

FIGS. 7A and 7B show an LED light system of the present invention mounted on a motorcycle fender on a straight bar which also includes a stop light and indicator lights and giving a 90 degree projection of light toward the ground, with FIG. 7A providing a view from behind the motorcycle and with FIG. 7B providing a side view of the motorcycle.

FIGS. 8A and 8B show an LED light system of the present invention mounted on a sportbike motorcycle fender on a straight bar which also includes a stop light and indicator lights and giving a 90 degree projection of light toward the ground, with FIG. 8A providing a view from behind the sportbike motorcycle and with FIG. 8B showing a side view of the sportbike motorcycle.

FIGS. 9A and 9B show an LED light system of the present invention mounted on the forks of a motorcycle fender and giving a 90 degree projection of light toward the ground, with FIG. 9A providing a view from in front of the motorcycle and with FIG. 9B providing a side view of the motorcycle.

FIGS. 10A and 10B show an LED light system of the present invention mounted on the forks of a sportbike motorcycle fender and giving a 90 degree projection of light toward the ground, with FIG. 10A providing a view from in front of the sportbike motorcycle and with FIG. 10B showing a side view of the sportbike motorcycle.

FIGS. 11A and 11B show an LED light system of the present invention mounted on the forks of a bicycle fender and giving a 90 degree projection of light toward the ground, with FIG. 11A providing a view from in front of the bicycle and with FIG. 11B providing a side view of the bicycle.

FIGS. 12A and 12B show an LED light system of the present invention mounted on the forks of a bicycle and giving a 90 degree projection of light toward the ground, with FIG. 12A providing a view from in front of the bicycle and with FIG. 12B providing a side view of the bicycle.

### DETAILED DESCRIPTION

The present invention is directed to an LED light system for lighting the ground underneath and around a motorcycle, and in certain embodiments also lighting the motorcycle itself, to make the motorcycle more visible at night. The system uses one or more high intensity LED lights which can be situated e.g. on or near the rear of the motorcycle to project light which highlights the ground behind and in front of the rear wheel of the motorcycle making the motorcycle more visible to motorists around the motorcycle. In certain embodiments, the LED lights of the present invention can instead, or in addition, be mounted in the middle of the motorcycle and can light the ground in front of the rear wheel and/or behind the front wheel and/or around the mid-section of the motorcycle. In certain other embodiments, the LED lights of the present invention can be located on or near the front of the motorcycle to project light which highlights the ground behind and in front of the front wheel of the motorcycle. In each of these situations, it is possible for the LED lights to light the motorcycle itself as well as the ground, without hindering the vision of motorists around the motorcycle or that of the operator of the motorcycle. Further, the LED light system of the present invention does not interfere with the lighting dynamics of the vehicle (e.g. the headlights, brake light and indicator lights) but instead function alongside the framework provided by each individual motorcycle.

The LED light system is mounted on a location of the motorcycle which allows light to be directed downward at an angle to the ground. The LED light system is preferably located at the rear end of the motorcycle and can be at or near where the brake lights are set. The LED light system is preferably mounted from the base of the fender (7) where the manufacturer's brake light (2) is mounted, or right behind it so as not interfere with the rear view braking system. In alternative embodiments, the LED light system can be mounted at or near the front of the motorcycle, e.g. on the forks of the motorcycle or alternatively on the triple tree (other known as a triple clamp) or in the middle of the motorcycle, e.g. on bracketing on the side of the motorcycle. In other embodiments, the lights can be mounted on e.g. the handles of the motorcycle or any other appropriate mounting area of a motorcycle that does not affect its performance. These alternative embodiments can be alone or in addition to LED lights located at or near the rear of the motorcycle. In each of these embodiments, it is also possible for the LED lights to light the motorcycle itself, in addition to lighting the ground.

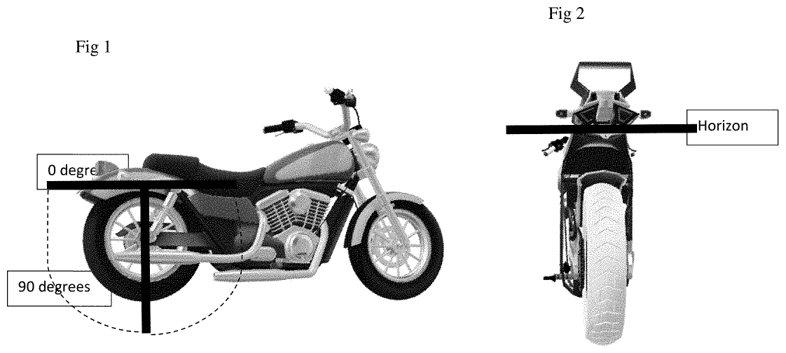

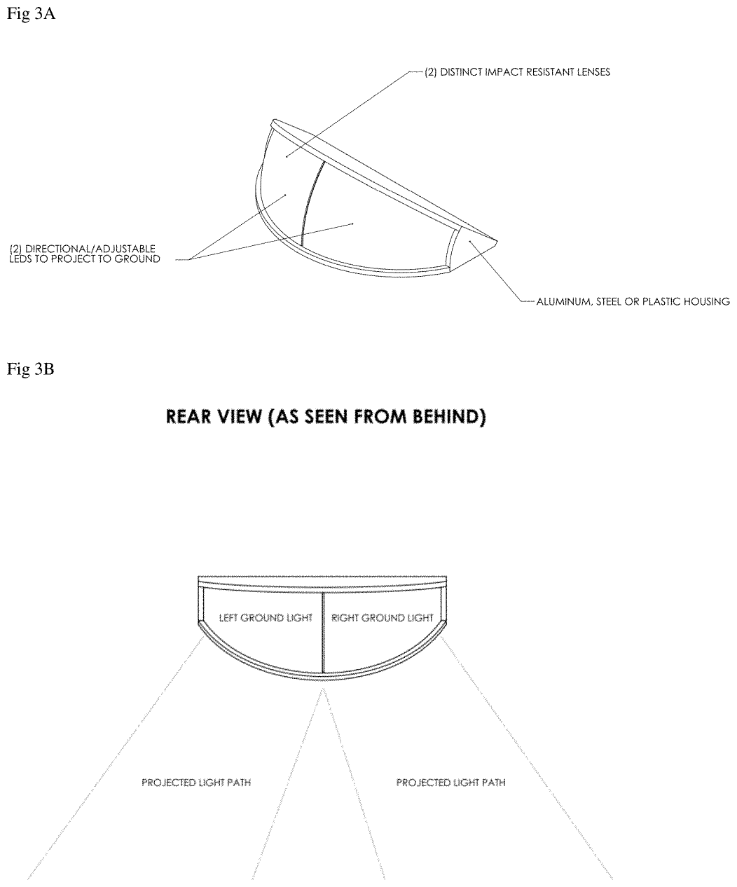

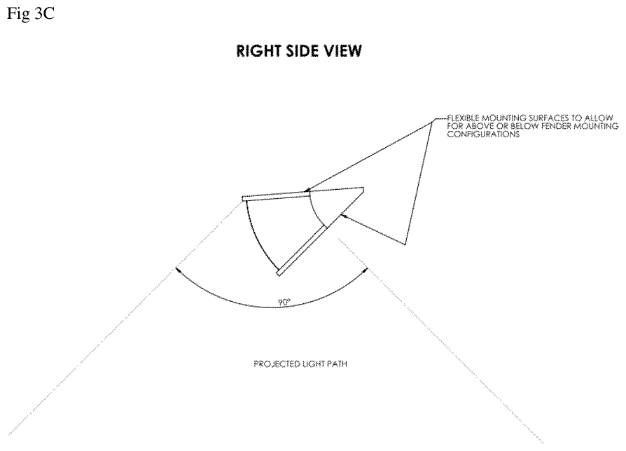

FIG. 1 shows an example of a motorcycle having an LED light system (1) mounted from the base of the fender where the manufacturer's brake light is mounted or right behind it and providing lighting downward at an angel of about 0 to about 180 degrees, measured from the base of the fender and/or the seat. FIG. 2 shows the horizon level which is the highest point at which the light is displayed. The downward projection of light can be at angles of less than 0 to 180 degrees, for example 5 to 175 degrees, 10 to 170 degrees, 5 to 170 degrees, 10 to 175 degrees, 45 to 135 degrees and so forth. In certain preferred embodiments the LED light shines an about 90 degree angle of light to the ground as shown in FIGS. 3B and 3C. It is important, however, that the projection of light not angle above 0 and 180 degrees, as shown in FIGS. 1 and 2 as the light could then cause a blinding affect to motorists, affecting their vision and endangering the safety of the motorcyclists and motorists alike.

In certain embodiments, an array of ground lighting can be provided by many LED lights. In other embodiments, only one or two LED lights are present in the LED light system. In one preferred embodiment, there are three separate LED lights, with one of the LED lights reacting to activation of the brake light, one of the LED lights reacting to activation of the right indicator light and the final LED light reacting to activation of the left indicator light. The LED lights may all shine at the same intensity. In certain embodiments, one or more of the LED lights are brighter to bring more attention to a particular element of the motorcycle (e.g. the brake light) or to the ground (e.g. directly behind the motorcycle)

In certain embodiments, the LED light system is automatically activated when the motorcycle is in operation. Alternatively, the LED light system can be manually operated. The LED light system may can be designed to only activate when there is low surrounding light (e.g. at night or when there are very dark clouds). The LED light system may increase in intensity when braking the motorcycle or may change to a different color. For example the light system may display a white light while the motorcycle is in motion and turn red when the brake is activated. In other embodiments, only one LED light or several LED lights in the LED light system are activated to increase intensity or change color when the brake is activated with the remainder of the LED light(s) remaining at the basic white light. The LED lights may also intensify when an indicator light is activated or change color. Alternatively, the lights may flash on and off when the indicator light is activated, may flash to a higher intensity when the indicator light is activated or may flash between white and another color or between two different colors when the indicator light is activated. As with the brake light, it is possible that only some and not all of the LED lights in the LED light system are activated by each of the left and right indicator lights.

FIGS. 3A to 3C show a universal light system contained within a housing (1) which includes a left indicator light/Led light (1) and a right indicator light/LED light (2). The left and right lights as shown in the FIGS. 3A to 3C are part of a single unit, but it is also possible for the left and right lights to be two separate units. The left and right LED lights project light toward the ground as shown in the projected light path (3). The indicator/LED lights are preferably covered by or coated with an impact resistant lens (4). As shown in FIG. 3C, the light system can include a flexible mounting surface (5) for mounting the universal light system e.g. above or below the fender of a motorcycle.

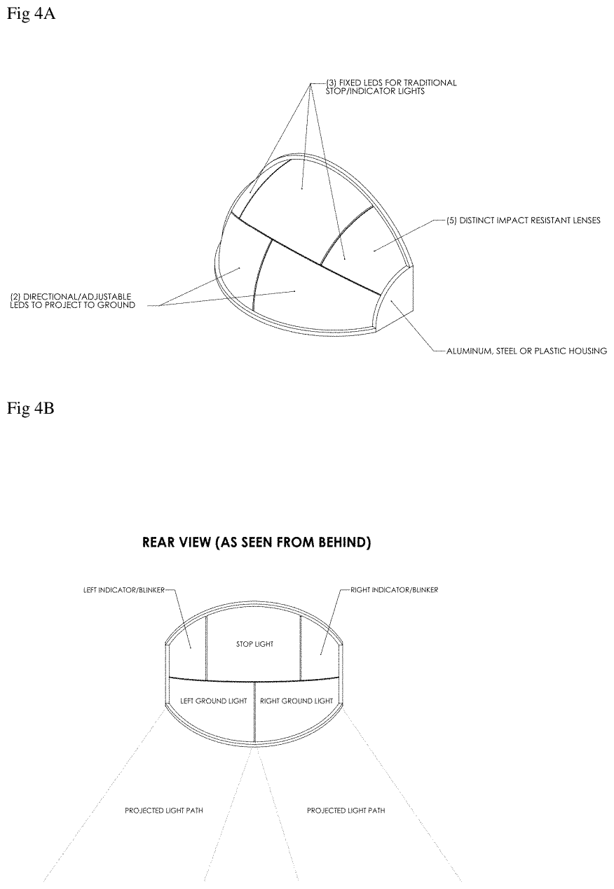

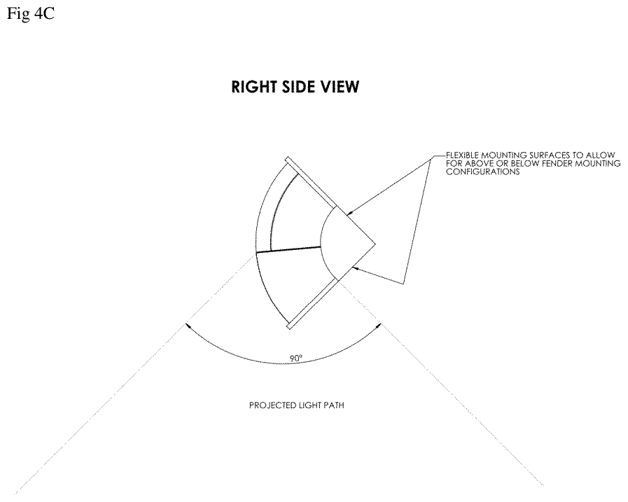

FIGS. 4A to 4C show another universal light system contained within a housing (1) which includes an integrated brake light (6), left and right indicator lights (7) and left and right LED lights (8) which project light in a path toward the ground (3). The left and right LED lights in certain embodiments also provide directional indication. The indicator/LED lights are preferably covered by or coated with an impact resistant lens (4). As shown in FIG. 4C, the light system can include a flexible mounting surface (5) for mounting the universal light system e.g. above or below the fender of a motorcycle.

In certain embodiments, the universal unit is designed to fit a variety of different motorcycle types. Alternatively, the LED light system can be included in brand or model specific units designed for different brands and models of motorcycle and the particular design of the brake light and indicator lights. These units can be sold together with an integrated brake light and/or indicator lights and can also include bracketing. It is also possible for the universal unit to include bracketing systems to attach the universal unit to a specific type of motorcycle or a general bracketing system for universal attachment.

It is also possible for the LED light system to be provided separately for addition to an existing brake light and indicator light system sold by the manufacturer. Such an LED light system can be one individual LED light or can be comprised of multiple connected LED lights or two or more individual lights.

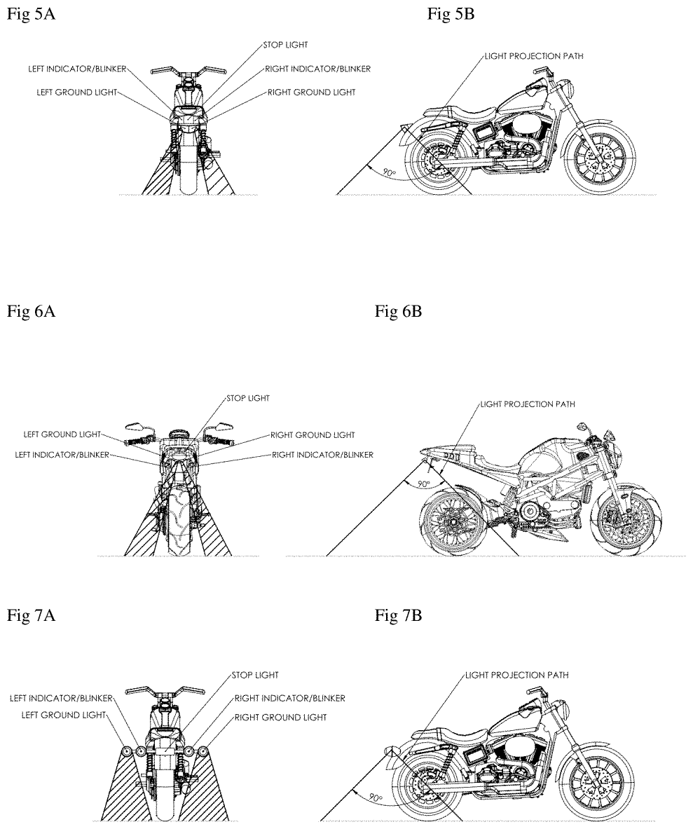

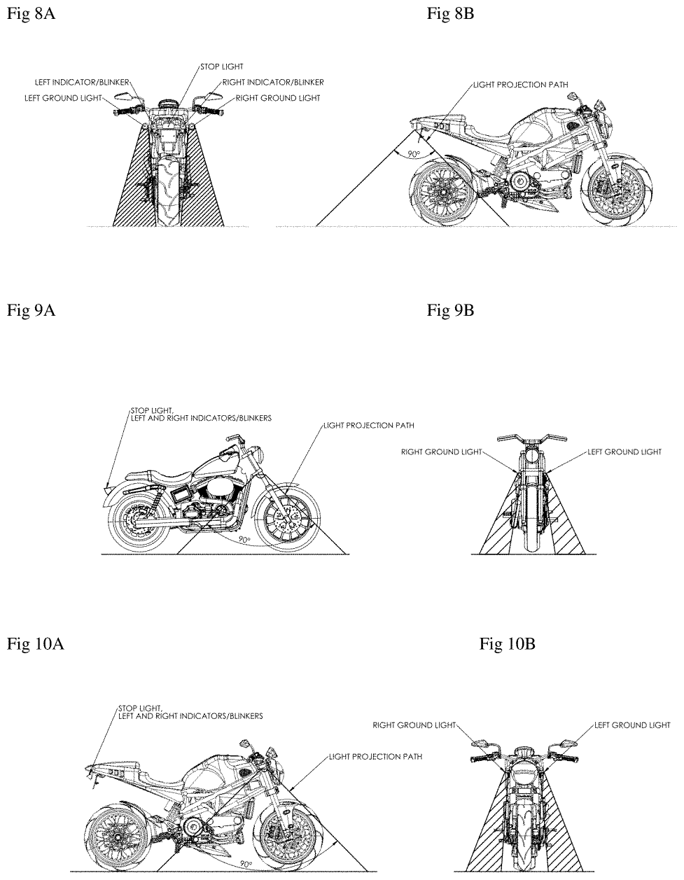

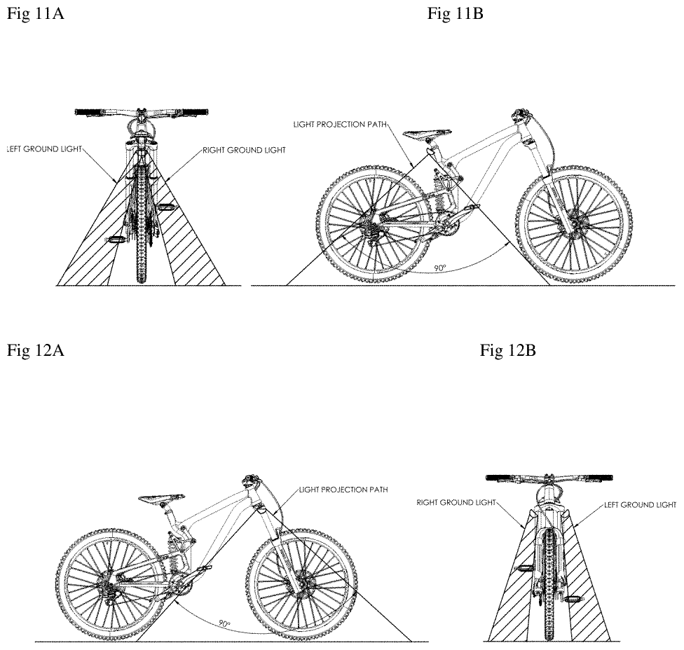

In certain embodiments, the LED light system can be attached either as part of a unit including a brake light and indicator lights or as a separate lighting system on a top surface of a motorcycle fender (see FIGS. 5A, 5B, 7A and 7B) or on the underside of a fender surface (see FIGS. 6A, 6B, 8A and 8B). In certain other embodiments, the LED light system be attached at or near the front of the motorcycle, e.g. on the forks of the motorcycle or on the triple tree (also known as a triple clamp), either as part of a unit including e.g. indicator lights or as a separate lighting system (see FIGS. 9A, 9B, 10A and 10B). These Figures and this description should in no way limit the manner and location in which the LED light system can be affixed to a motorcycle as this will depend on the different shapes and configurations of different brands and models of motorcycle and proper attachment would be well within the knowledge of one of skill in the art.

In certain embodiments, the lumen range is from about 2,400 lm to about 10,000 lm. Varying lumens are possible, as for example, colored lighting is of higher/brighter lumens while the white light/brake lights are of lower lumen. When the LED light system is mounted at the front end of the motorcycle, the lumen range of the lights can be from about 4,000 lm to about 8,000 lm. When the LED light system is mounted at the rear end of the motorcycle, the lumen range of the lights is from about 1,400 lm to about 3,500 lm. In certain embodiments, such as when the LED light is integrated with the brake light of the motorcycle, the lumen range is preferably from about 2,300 lm to about 3,000 lm. In certain embodiments of the present invention, varying lumen strengths can be used to achieve brighter or dimmer projections at desired locations around the motorcycle to both enhance visibility of the motorcycle while preventing impact to the vision of any drivers in the vicinity of the motorcycle.

The one or more LED lights in the LEI) light system of ent invention can be arranged in a variety of different configurations to provide the array of light to the ground and in certain embodiments also to the motorcycle itself. In certain embodiments, the LED light system provides one or more LED lights which are curved around the side of the motorcycle (i.e., extend from back to each side). This increased surface area of light at the sides of the motorcycle gives the motorcycle an even bigger light profile so that the motorcycle appears larger and is more visible from different viewing perspectives. This can be seen e.g. in the side motorcycle views of FIGS. 5B, 6B, 7B, 8B, 9B and 10B.

The LED lights can attach directly to a power source of the motorcycle such as existing lighting wiring of the motorcycle. In certain preferred embodiments, the LED light system is wired into the braking light for power. In certain embodiments, the LED light system will have a power lead, ground and trigger. In other embodiments, the LED light system is powered by a power source separate from the motorcycle such as an external battery source. In further embodiments, the batteries can be changed or can be rechargeable. In other embodiments, the LED lights themselves can be replaced. When the LED lights are attached to an external battery pack, the external batter pack/power source may be attached to the motorcycle by e.g. a screw set, wire straps or any other appropriate harness method to a suitable location on the underside of the motorcycle.

The LED light(s) can be ill any shape such as a straight bar, an oval, a dome sir a circle. In preferred embodiments, the LEI) light(s) are shaped in a semi-circle dome as shown in Figure SA. In another preferred embodiment, the LED light(s) are located on a straight bar which also includes the brake light (see e.g. FIGS. 7A, 7B, 8A, 8B).

In certain embodiments, the LED light system may be contained together with the brake light and indicator lights in a housing (1). In certain embodiments, the tail light and the brake light are separate lights and a tail light is also contained in the housing (1). The housing (4) be made e.g. of aluminum, steel or plastic. (see FIG. 3A) The housing (1) may provide a flexible mounting surface (8) to allow for above or below the fender mounting of the LED light system to the motorcycle. (see FIG. 3C)

In certain embodiments of the present invention, the LED lights are adjustable, to allow the angle of the light beam to be changed. The LED lights may also be adjustable so that they can be dimmed or made brighter.

In certain embodiments, the LED light is covered by an impact resistant lens or coating.

### CONCLUSION

In the preceding specification, the invention has been described with reference to specific exemplary embodiments and examples thereof. It will, however, be evident that various modifications and changes may be made thereto without departing from the broader spirit and scope of the invention as set forth in the claims that follow. The specification and drawings are accordingly to be regarded in an illustrative manner rather than a restrictive sense.

1. A motorcycle LED light system for lighting the ground underneath and around a motorcycle, to make the motorcycle more visible, comprising one or more high intensity LED lights situated on or near the rear of the motorcycle and in a direction so that the LED light is projected toward the ground behind and in front of the rear wheel of the motorcycle.

2. The LED light system of claim 1, wherein the motorcycle itself is also illuminated.

3. The LED light system of claim 1, wherein the one or more LED lights is integrated with a brake light and, when the brake light is activated, the one or more LED lights grows brighter or changes color to indicate that the brake has been activated.

4. The LED light system of claim 3, wherein a first LED light of the light system is integrated with a left indicator light and a second LED light of the light system is integrated with the right indicator light and wherein when one of the indicator lights is activated, the integrated LED light grows brighter or changes color to indicate that the indicator has been activated.

5. The LED light system of claim 3, wherein a first LED light of the light system is integrated with a left indicator light and a second LED light of the light system is integrated with the right indicator light and wherein when one of the indicator lights is activated, the integrated LED light flashes on and off or flashes from on to a brighter setting or to a color setting to indicate that the indicator has been activated.

6. The LED light system of claim 1, wherein the LED light has a lumen range of from about 2,300 lm to about 3,000 lm.

7. The LED light system of claim 6, wherein at least one LED light is integrated with the brake light and is brighter than other LED lights in the system.

8. The LED light system of claim 1 providing lighting downward at an angel of about 0 to about 180 degrees, measured from the base of the fender.

9. The LED light system of claim 1 providing lighting downward at an angel of about 45 to about 135 degrees, measured from the base of the fender.

10. The LED light system of claim 1, wherein the LED light system is mounted from the base of the fender or right behind it so as not interfere with the rear view braking system and providing lighting downward at an angel of at least about 45 degrees to about 135 degrees but no more than about 0 degrees to about 180 degrees.

11. The LED light system of claim 1, wherein the one or more LED lights is curved around both sides of the motorcycle from the back to each side to increase a surface area of light at the sides of the motorcycle to give the motorcycle a bigger light profile such that the motorcycle appears larger and is more visible from different viewing perspectives.

12. The LED light system of claim 1, wherein at least one LED light is automatically activated when the motorcycle is in operation.

13. The LED light system of claim 1 wherein at least one LED light is only activated when there is low surrounding light (e.g. at night or when there are very dark clouds).

14. The LED light system of claim 1, wherein the LED lights are adjustable to allow the angle of the light beam to be changed.

15. A housing for containing lighting for a motorcycle comprising:
A) a brake light;
B) left and right indicator lights
C) an LED light system comprised of at least one LED light positioned to light the ground around the rear wheel of the motorcycle.

16. The LED light system of claim 1 wherein the LED light system is contained in a housing with a brake light and indicator lights as a universal kit to fit a number of different brands and models of motorcycle.

17. A method of lighting the ground in front and behind a motorcycle so that the motorcycle is significantly more visible at night comprising attaching to the motorcycle an LED light system comprising one or more LED lights which are directed toward the ground at an angel of at least about 45 degrees to about 135 degrees but no more than about 0 degrees to about 180 degrees measured from the base of the back fender of the motorcycle.

18. The LED light system of claim 1 wherein the LED light system includes LED lights located at or near the front of the motorcycle which light the ground in front and behind the front wheel of the motorcycle.

19. The LED light system of claim 15, wherein the LED light system is contained in a housing with a brake light and indicator lights as a universal kit to fit a number of different brands and models of motorcycle.

20. A motorcycle LED light system for lighting the ground underneath and around a bicycle to make the bicycle more visible, comprising one or more high intensity LED lights situated on or near the rear of the bicycle and in a direction so that the LED light is projected toward the ground behind and in front of the rear wheel of the bicycle.
